(19) United States
(12) Patent Application Publication
(10) Pub. No.: US 2026/0270581 A1
(43) Pub. Date: Sep. 10, 2026

(54) HIGH DYNAMIC RANGE SOLID-STATE IMAGING DEVICE

(71) Applicant: Sony Semiconductor Solutions Corporation, Kanagawa (JP)

(72) Inventor: Koji OGAWA, Zürich (CH)

(73) Assignee: Sony Semiconductor Solutions Corporation, Kanagawa (JP)

(21) Appl. No.: 19/165,596

(22) PCT Filed: Mar. 13, 2024
(86) PCT No.: PCT/EP2024/056635

§ 371 Date: Sep. 16, 2025

(30) Foreign Application Priority Data
Mar. 29, 2023 (EP) 23165140.7

(51) Int. Cl. H04N 25/571; H04N 25/47; H04N 25/51; H04N 25/707; H04N 25/77; H04N 25/78

(52) U.S. Cl. CPC H04N 25/573; H04N 25/47; H04N 25/51; H04N 25/707; H04N 25/77; H04N 25/78

(57) ABSTRACT

A radiation sensitive circuit continuously converts a first photocurrent generated by incident radiation into a pixel voltage signal VPR and outputs a gain control signal VGC based on a voltage level of the pixel voltage signal VPR. An active pixel circuit integrates a second photocurrent generated by incident radiation in an exposure period and converts a resulting electric charge into a pixel output voltage VSL at a conversion gain controllable by the gain control signal VGC.

The present disclosure relates to a solid-state imaging device with active pixel circuits and high dynamic range. More particularly, the present disclosure relates to a solid-state imaging device using different conversion gains.

### BACKGROUND

In solid-state imaging devices, photoelectric conversion elements generate a photocurrent proportional to the received radiation energy. In solid-state imaging devices with active pixel sensor (APS), active pixel circuits convert the small photocurrents into analog voltage signals and output the analog voltage signals on data signal lines. A high conversion gain allows image information to be extracted even from dark image sections of the image but can result in overexposure of bright image sections. A low conversion gain allows image information to be extracted even from bright image sections, but results in underexposure of dark image sections. High dynamic range (HDR) solid-state imaging devices sequentially capture two images with different conversion gains and stitch the final image together by reverting to the low conversion gain image for bright pixels and the high conversion gain image for dark pixels, effectively extending the dynamic range of the APS.

### SUMMARY

HDR solid-state imaging devices combine images obtained from the same scene at two successive points in time and therefore reduce the best possible frame rate by factor ½. Where the captured scene contains fast moving objects, typical motion artefacts can be visible in the final image compiled from the two images obtained at different conversion gains

The present disclosure mitigates such shortcomings of the prior art. In particular, the present disclosure provides a means for each pixel circuit to use the appropriate conversion gain for each individual exposure. The solid-state imaging device captures a single image, with each single pixel circuit using the more appropriate conversion gain for the instantaneous illumination conditions.

Accordingly, a solid-state imaging device in accordance with the present disclosure includes a radiation sensitive circuit and at least one active pixel circuit. The radiation sensitive circuit continuously converts a first photocurrent generated by incident radiation into a pixel voltage signal, and outputs a gain control signal that is based on a voltage level of the pixel voltage signal. The active pixel circuit integrates a second photocurrent generated by incident radiation in an exposure period and converts a resulting electric charge into a pixel output voltage at a conversion gain controllable by the gain control signal.

The pixel voltage signal output from the radiation sensitive circuit directly follows the incident radiation intensity and continuously monitors the brightness received in a particular section of the solid-state imaging device. The pixel voltage signal can be continuously compared with a threshold voltage. A result of the comparison can be used to control active pixel circuits to operate at a high conversion gain when the pixel voltage signal indicates low radiation intensity and at a low conversion gain when the pixel voltage signal indicates high radiation intensity. Each HDR image can be obtained with a single exposure. The frame rate is not affected. Motion artifacts caused by double exposure do not occur.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram illustrating a configuration example of an imaging apparatus as an example for an electronic device that includes a solid-state imaging device with radiation sensitive circuits and active pixel circuits in accordance with the embodiments of the present technology.

FIG. 2 is a simplified block diagram of an HDR solid-state imaging device with active pixel circuits and radiation sensitive circuits outputting a gain control signal to control the conversion gain of the active pixel circuits in accordance with an embodiment of the present technology.

FIG. 3 is a schematic simplified plan view of an arrangement of photoelectric conversions elements for radiation sensitive circuits and active pixel circuits in accordance with an embodiment.

FIG. 4 is a simplified circuit diagram illustrating a configuration example of a radiation sensitive circuit with a photoreceptor circuit for converting a photocurrent into a voltage in accordance with an embodiment.

FIG. 5 is a simplified circuit diagram illustrating a configuration example of a radiation sensitive circuit in accordance with an embodiment related to a photoreceptor circuit including a logarithmic amplifier circuit.

FIG. 6 is a simplified circuit diagram illustrating a configuration example of a radiation sensitive circuit in accordance with an embodiment related to a photoreceptor circuit including a logarithmic amplifier circuit with enhanced gain.

FIG. 7 is a simplified diagram illustrating a dynamic range of a radiation sensitive circuit in accordance with an embodiment related to a photoreceptor circuit including a logarithmic amplifier circuit.

FIG. 8 is a simplified circuit diagram illustrating a configuration example of a radiation sensitive circuit in accordance with an embodiment related to a radiation sensitive circuit with a light level judgement circuit and a latch circuit for obtaining a gain control signal.

FIG. 9 is a simplified circuit diagram illustrating a configuration example of a latch comparator circuit for a radiation sensitive circuit in accordance with an embodiment.

FIG. 10 is a simplified circuit diagram illustrating another configuration example of a radiation sensitive circuit with a latch comparator circuit and a flag signal output circuit in accordance with an embodiment.

FIG. 11 illustrates schematic time diagrams for input signals and output signals of the radiation sensitive circuit illustrated in FIG. 10 in accordance with an embodiment.

FIG. 12 is a simplified block diagram of a threshold defining circuit for radiation sensitive circuits in accordance with a further embodiment.

FIG. 13 is a simplified circuit diagram illustrating a configuration example of a radiation sensitive circuit in accordance with an embodiment related to a radiation sensitive circuit that includes an event detection circuit.

FIG. 14 is a simplified block diagram of an HDR solid-state imaging device with active pixel circuits and radiation sensitive circuits outputting both event signals and a gain control signal to control the conversion gain of the active pixel circuits in accordance with an embodiment of the present technology.

FIG. 15 is a simplified circuit diagram illustrating a configuration example of an active pixel circuit with a controllable floating diffusion capacitance in accordance with an embodiment.

FIG. 16 is a simplified circuit diagram illustrating another configuration example of an active pixel circuit with a controllable floating diffusion capacitance in accordance with a further embodiment.

FIG. 17A and FIG. 17B show interconnected parts of a simplified circuit diagram showing a macro pixel that includes a radiation sensitive circuit configured as event detection circuit and active pixel circuits for various colors in accordance with a further embodiment.

FIG. 18 illustrates schematic time diagrams for input signals of the macro pixel illustrated in FIG. 17A and FIG. 17B in accordance with an embodiment.

FIG. 19 illustrates a simplified flow chart for illustrating a method of compiling digital pixel values from the gain flag signal and the pixel output voltages of the active pixel circuits in accordance with an embodiment.

FIG. 20 is a schematic diagram for illustrating the calculation of digital pixel values of a macro pixel in accordance with an embodiment.

FIG. 21 is a simplified plan view of a macro pixel including both a radiation sensitive circuit configured as event detection circuit and active pixel circuits for various colors in accordance with a further embodiment.

FIG. 22 is a diagram showing an example of a laminated structure of a solid-state imaging device in accordance with a further embodiment of the present disclosure.

FIG. 23A and FIG. 23B show details of a top chip and a bottom chip for the laminated structure of FIG. 22 in accordance with an embodiment.

FIG. 24 is a block diagram depicting an example of a schematic configuration of a vehicle control system.

FIG. 25 is a diagram of assistance in explaining an example of installation positions of an outside-vehicle information detecting section and an imaging section of the vehicle control system of FIG. 24.

### DETAILED DESCRIPTION

Embodiments for implementing techniques of the present disclosure (also referred to as “embodiments” in the following) will be described below in detail using the drawings. The techniques of the present disclosure are not limited to the described embodiments, and various features in the embodiments are illustrative only. The same elements or elements with the same functions are denoted by the same reference signs. Duplicate descriptions are omitted.

Directly electrically connected electronic elements may be electrically connected through a direct, permanent low-resistive ohmic connection, e.g., through a conductive line, an ohmic contact or a heavily doped semiconductor region. The terms “electrically connected” and “signal-connected” may also include a connection through other electronic elements provided and suitable for permanent and/or temporary signal transmission and/or transmission of energy. Electronic elements can be electrically connected or signal-connected via resistors, capacitors, electronic switches such as field effect transistors (FETs), or transistor circuits such as transmission gates. The load path of a transistor is the controlled path of a transistor. For example, a voltage applied to a gate of a FET controls by field effect the current flow in the load path between source and drain.

Any digital signal can be a binary amplitude signal that alternates between an active voltage level and an inactive voltage level. The active voltage level can be a logic high level and the inactive voltage level can be a logic low level. Alternatively, the active voltage level may be a logic low level and the inactive voltage level may be a logic high level. A signal with the active level is referred to as an “active signal”. A signal with the inactive level is referred to as an “inactive signal”.

Though in the following a technology for conversion gain control in HDR solid-state imaging devices is described in the context of certain types of active pixel circuits with controllable conversion gain, the technology may also be used for other types of active pixel circuits with controllable conversion gain.

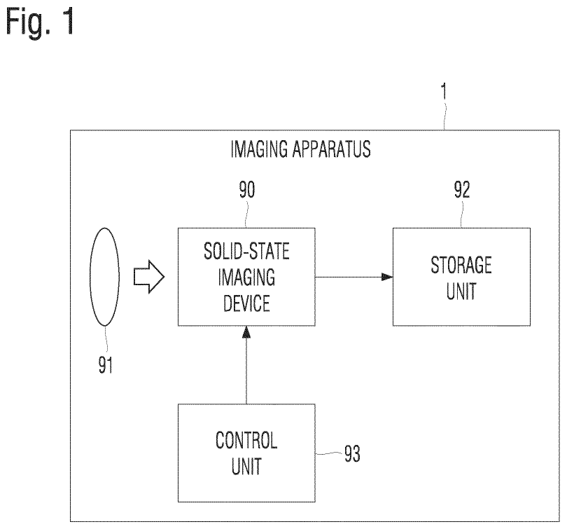

In FIG. 1, an imaging apparatus 1 includes an optical system 91, a solid-state imaging device 90, a storage unit 92, and a control unit 93. The optical system 91 includes one or more lenses and various mechanisms such as an autofocus mechanism and a diaphragm mechanism, and guides light from an object to a light receiving surface of the solid-state imaging device 90.

The solid-state imaging device 90 includes an image sensor having a plurality of active pixel circuits. Each active pixel circuit includes a photoelectric conversion element that converts incident radiation into electric signals by photoelectric conversion, and outputs the electric signals. The solid-state imaging device 90 further includes a signal processing unit that performs predetermined signal processing on the electric signals output from the active pixel circuits and outputs image data based on the electric signals.

The storage unit 92 stores the image data output from the solid-state imaging device 90 in a storage medium. The storage medium may include a volatile storage medium and/or non-volatile storage medium. The non-volatile storage medium may be or include a flash memory or a hard disk drive. The non-volatile storage medium may be or include a dynamic random access memory (DRAM).

The control unit 93 controls the solid-state imaging device 90, such that the solid-state imaging device 90 performs an imaging operation. The imaging operation includes capturing an image of an object or a scene and outputting image data including image information about the intensity distribution.

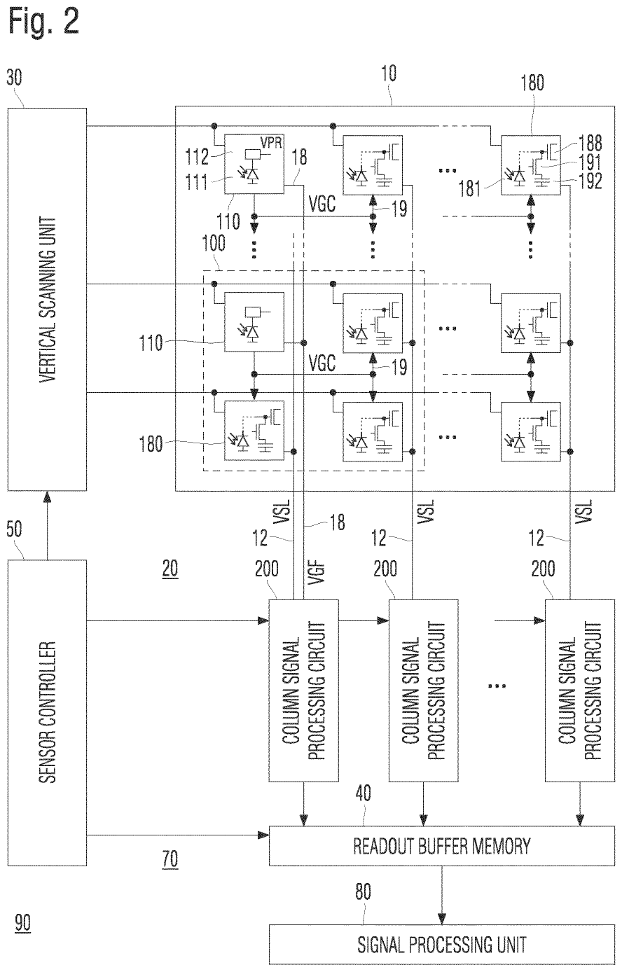

FIG. 2 illustrates a configuration example of a solid-state imaging device 90 in accordance with embodiments of the present technology. The solid-state imaging device 90 includes an image sensor assembly 70 and a signal processing unit 80. The image sensor assembly 70 includes a pixel array 10, a column signal processing unit 20, a vertical scanning unit 30, a readout buffer memory 40 and a sensor controller 50.

The pixel array 10 of the solid-state imaging device 90 includes a radiation sensitive circuit 110 and an active pixel circuit 180. The radiation sensitive circuit 110 continuously converts a first photocurrent generated by incident radiation into a pixel voltage signal VPR, and outputs a gain control signal VGC that is based on a voltage level of the pixel voltage signal VPR. The active pixel circuit 180 integrates a second photocurrent generated by incident radiation and converts a resulting electric charge into a pixel output voltage VSL at a conversion gain controllable by the gain control signal VGC.

The radiation sensitive circuits 110 and the active pixel circuits 180 of the solid-state imaging device 90 are assigned to macro pixels 100. Each macro pixel 100 may include one radiation sensitive circuit 110 and one or more active pixel circuits 180 with controllable conversion gain.

In the illustrated embodiment, the radiation sensitive circuit 110 includes a first photoelectric conversion element 111 in which incident radiation generates the first photocurrent. A photoreceptor circuit continuously converts the first photocurrent into the pixel voltage signal VPR. The radiation sensitive circuit 110 evaluates the pixel voltage signal VPR and generates a gain control signal VGC in response to a voltage level of the pixel voltage signal VPR.

The gain control signal VGC may be a digital signal changing between an active voltage level and an inactive voltage level. The radiation sensitive circuit 110 may output an active gain control signal VGC when the pixel voltage signal indicates a high intensity of the incident radiation and an inactive gain control signal VGC when the pixel voltage signal indicates a low intensity.

The radiation sensitive circuit 110 outputs the gain control signal VGC on a gain signal line 19 that connects the radiation sensitive circuit 110 with the active pixel circuits 180 of the same macro pixel 100. The gain control signal VGC can be updated for each exposure period of the active pixel circuit 180.

In addition, the radiation sensitive circuit 110 may generate a gain flag signal VGF indicating the voltage level of the gain control signal for a certain exposure period. The gain flag signal VGF may be a digital signal changing between an active voltage level and an inactive voltage level. The radiation sensitive circuit 110 outputs an active gain flag signal VGF in response to an active gain signal VGC and an inactive gain flag signal VGF in response to an inactive gain signal VGC.

The radiation sensitive circuit 110 may output the gain flag signal VGF on a flag signal line 18 in a flag readout period. The flag signal line 18 electrically connects the radiation sensitive circuit 110 with the column signal processing unit 20.

The active pixel circuits 180 are suitable for intensity readout at a controllable gain. Each active pixel circuit 180 may include one or two second photoelectric conversion elements 181 generating a second photocurrent and three, four or more field effect transistors (FETs). The active pixel circuit 180 integrates the second photocurrent by accumulating charge during an exposure period. The accumulated charge is stored on a first electrode of a floating diffusion capacitor electrically connected to a gate of an amplifier transistor 188. A floating diffusion region may form the first electrode of a floating diffusion capacitor.

For each active pixel circuit 180, the amplifier transistor 188 is in a source follower configuration with elements of the column signal processing unit 20, wherein a load path of the amplifier transistor 188 is electrically connected between a positive pixel supply voltage VDDH and a data signal line 12. The amplifier transistor 188 outputs the pixel output voltage VSL on the data signal line 12, wherein the pixel output voltage VSL is a function of the amount of electric charge stored on the first electrode of the floating diffusion capacitor.

A conversion gain at which the active pixel circuits 180 convert a difference in incident radiation into a difference in the pixel output voltage VSL is controllable. In the illustrated embodiment, the active pixel circuits 180 include floating diffusion transistors 191 and supplementary capacitive structures 192. The floating diffusion transistors 191 of the same macro pixel 100 receive the same gain control signal VGC.

An inactive gain control signal VGC turns off the floating diffusion transistors 191 such that the electric charge accumulated during an exposure period is sampled on the floating diffusion capacitor alone. A small amount of charge can result in a large change of the floating diffusion potential VFD and the conversion gain is high.

An active gain control signal VGD turns on the floating diffusion transistors 191 such that the electric charge accumulated during an exposure period is sampled on a capacitive structure with higher capacitance.

A greater amount of charge can be stored at the gate input of the amplifier transistor 188 for the same floating diffusion potential.

The first and second photoelectric conversion elements 111, 181 of the pixel array 10 may be arranged matrix-like along columns and rows. A subset of radiation sensitive circuits 110 and active pixel circuits 180 assigned to the same column of photoelectric conversion elements 111, 181 may form a pixel column. A subset of radiation sensitive circuits 110 and active pixel circuits 180 assigned to the same row of photoelectric conversion elements 111, 181 may form a pixel row.

The vertical scanning unit 30 generates pixel control signals for operating and selecting groups of radiation sensitive circuits 110 and active pixel circuits 180. The pixel control signals control pixel reset, pixel exposure, pixel-internal temporal storage of illumination information, and output of the pixel output voltage VSL through the data signal lines 12.

The vertical scanning unit 30 controls all active pixel circuits 180 of a selected group of active pixel circuits 180 synchronously. The selected group of active pixel circuits 180 may include some active pixel circuits 180 of one pixel row, all active pixel circuits 180 of one pixel row, or some or all active pixel circuits 180 of more than one pixel row. In the following part of the description, “pixel row” is often referred to as an example of “group of pixel circuits” for simplicity. The vertical scanning unit 30 outputs the control signals for operation of the transistors of the active pixel circuits 180 according to driver timing signals provided by the sensor controller 50.

The amplifier transistors 188 of a pixel output group sequentially output the pixel output voltages of a pixel output group to one or two data signal lines (vertical signal lines) 12. Each pixel output group may include some active pixel circuits 180 of one pixel column, all active pixel circuits 180 of one pixel column, or some or all active pixel circuits 180 of more than one pixel column. In the following part of the description, “pixel column” is often referred to as an example of “pixel output group” for simplicity. On each data signal line 12, pixel output voltages VSL from the active pixel circuits 180 of one of the pixel columns are sequentially transmitted to the column signal processing unit 20.

The column signal processing unit 20 may include a column signal processing circuit 200 for each data signal line 12 or for each pair of data signal lines 12. Each column signal processing circuit 200 further receives the gain flag signal VGF which includes information about the gain used in a macro pixel 100. Based on the information about the gain, the column signal processing circuit 200 converts the pixel output voltages VSL into digital pixel values, may preprocess the digital pixel values and outputs the digital pixel values or the preprocessed digital pixel values to the readout buffer memory 40. The readout buffer memory 40 temporarily stores the digital pixel values.

The sensor controller 50 generates the driver timing signal and outputs the driver timing signals to the vertical scanning unit 30. The sensor controller 50 generates column control signals for controlling the column signal processing unit 20 and may generate a readout control signal that controls the readout of the digital pixel values from the readout buffer memory 40 to the signal processing unit 80 and/or to a digital interface.

In the solid-state imaging device of FIG. 2, a pixel voltage signal VPR of the radiation sensitive circuit 110 of a macro pixel 100 directly follows the incident radiation intensity and continuously indicates an instantaneous intensity of the incident radiation. The radiation sensitive circuit 110 compares the pixel voltage signal VPR with a gain threshold voltage and outputs a gain control signal VGC. A voltage level of the gain control signal VGC depends on a result of the comparison between the pixel voltage signal VPR with the gain threshold voltage. The gain control signal VGC controls the gain of the active pixel circuits 180 of the macro pixel 100.

Each active pixel circuit 180 includes a controllable element that allows to change the conversion gain of the active pixel circuit 180. The controllable element may change between a first state and a second state. When the active pixel circuit 180 receives an active gain control signal VGC, the controllable element is in or changes into the first state and the conversion gain of the active pixel circuit is low. When the active pixel circuit 180 receives an inactive gain control signal VGC, the controllable element is in or changes into the second state and the conversion gain of the active pixel circuit is high.

When the radiation sensitive circuit 110 receives little light, a voltage level of the pixel voltage signal VPR is low and below the gain threshold voltage. The radiation sensitive circuit 110 outputs an inactive gain control signal VGC. The active pixel circuit 180 receives the inactive gain control signal VGC and operates at a high gain in response thereto so that the active pixel circuit 180 can operate at a high resolution during low light conditions.

When the radiation sensitive circuit 110 receives a lot of light, a voltage level of the pixel voltage signal VPR is high and above the gain threshold voltage. The radiation sensitive circuit 110 outputs an active gain control signal VGC. The active pixel circuit 180 receives the active gain control signal VGC at and operates at a low gain in response thereto so that the active pixel circuit 180 does not saturate in bright light conditions.

Each column signal processing circuit 200 receives pixel output voltages VSL of an active pixel circuit 180 in a row readout period and converts the received pixel output voltages VSL into digital pixel values. Each column signal processing circuit 200 may include an arithmetic logic unit for preprocessing the digital pixel values. For each row readout, the arithmetic logic unit may calculate corrected pixel values from a digital pixel value obtained in a reset phase (P phase) and a digital pixel value obtained from the same active pixel circuit 180 in the data phase (D phase). The arithmetic logic unit may perform DCDS (digital correlated double sampling) and subtract the digital pixel value obtained in the reset phase from the digital pixel value obtained from the same active pixel circuit 180 in the data phase to obtain the corrected pixel value. The data phase may follow the reset phase in the same row readout period.

The flag signal lines 18 pass the gain flag signals VGF to the column signal processing circuits 200. The column signal processing circuits 200 use the gain flag signals received row-by-row through the flag signal lines 18 in flag readout periods and weight the digital pixel values according to the state of the received gain flag signal.

The column signal processing circuits 200 output the digital pixel values to a readout buffer memory 40. The readout buffer memory 40 temporarily stores the digital pixel values.

Provided that the incident radiation received by the radiation sensitive circuit 110 has an intensity which is within the same order of magnitude as the intensity of radiation received by the active pixel circuit 180, each active pixel circuit 180 operates for each frame with the suitable gain. Each HDR image can be obtained with a single exposure. The frame rate is not affected. Motion artifacts caused by double exposure and subsequent compilation of an HDR image based on two successively captured images obtained at different gains can be avoided.

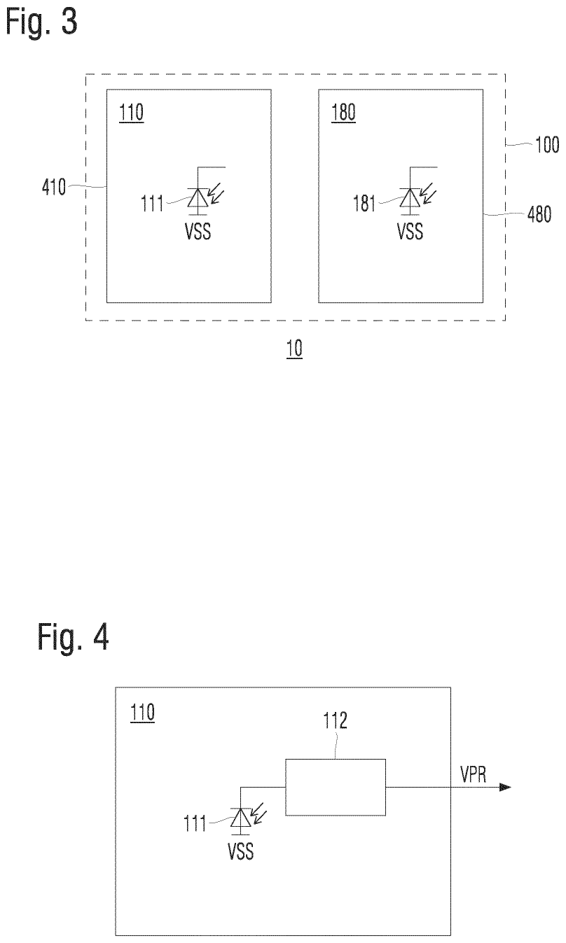

FIG. 3 shows a macro pixel 100 of the pixel array 10 of a high dynamic range solid-state imaging device. The pixel array 10 may include a plurality of identical macro pixels 100 or such macro pixels 100 that differ in the number of active pixel circuits 180. The illustrated macro pixel 100 includes one radiation sensitive circuit 110 and one active pixel circuit 180.

The radiation sensitive circuit 110 may include a first photoelectric conversion element 111 that generates the first photocurrent from radiation incident in a first detector region 410. The active pixel circuit 180 includes a second photoelectric conversion element 181 configured to generate the second photocurrent from radiation incident in a second detector region 480 neighboring the first detector region 410.

The first detector region 410 and the second detector region 480 can be laterally separated by an idle region. Radiation incident in the idle region does not contribute to the first and/or second photocurrents, or only to a negligible extent. The first detector region 410 and the second detector region 480 can be adjacent to each other on opposite sides of the idle region with no further detector region of another macro pixel 100 formed directly between the first detector region 410 and the second detector region 480.

A macro pixel 100 can include one radiation sensitive circuit 110 and two or more active pixel circuits 180. The radiation sensitive circuit 110 can include several first photoelectric conversion elements 111 each receiving incident radiation in another first detector region 410. Each active pixel circuit 180 can include several second photoelectric conversion elements 181 each receiving incident radiation in another second detector region 480. Among all first detector regions 410 and second detector regions 480 of the same macro pixel 100, at least one second detector region 480 can be adjacent to one of the first detector regions 410.

The first and second detector regions 410, 480 of a macro pixel 100 can be arranged within a smallest possible rectangle that encompasses all first and second detector regions 410, 480 of the macro pixel 100, wherein first and/or second detector regions 410, 480 of other macro pixels 100 occupy at most 50% or at most 20% of the area of the smallest possible rectangle. According to an example, for each macro pixel 100, all first and second detector regions 410, 480 are formed within a rectangular area that does not include a first and/or second detector region 410, 480 of any other macro pixel 100.

Given the small distance between the first detector region 410 and the second detector region 480, the intensity of the radiation incident in the first detector region 410 is very likely to be on the same side of the gain threshold voltage as the radiation incident in the second detector region 480. The gain control signal encodes the appropriate gain for the active pixel circuits 180 with high probability.

FIG. 4 shows a radiation sensitive circuit 110 that includes a first photoelectric conversion element 111 and a photoreceptor circuit 112. The photoelectric conversion element 111 generates the first photocurrent in response to the incident radiation. The photoreceptor circuit 112 converts the first photocurrent into the pixel voltage signal VPR.

The first photoelectric conversion element 111 may include or consist of a photodiode which by means of the photoelectric effect converts electromagnetic radiation incident on a detection surface in a first detector region of the radiation sensitive circuit 110 into the first photocurrent. The electromagnetic radiation may include visible light, infrared radiation and/or ultraviolet radiation. The amplitude of the first photocurrent corresponds to the intensity of the incident electromagnetic radiation, wherein in the intensity range of interest the first photocurrent may increase approximately linearly with increasing intensity of the detected electromagnetic radiation.

The photoreceptor circuit 112 converts the first photocurrent into the pixel voltage signal VPR. The voltage of the pixel voltage signal VPR is a function of the first photocurrent, wherein in the voltage range of interest the voltage amplitude of the pixel voltage signal VPR continuously increases with continuously increasing first photocurrent. For example, the voltage amplitude of the pixel voltage signal VPR may linearly increase with linearly increasing first photocurrent.

A voltage level of the pixel voltage signal VPR can monotonically increase with increasing intensity of the incident radiation. Accordingly, the voltage level of the pixel voltage signal VPR monotonically decreases with decreasing intensity of the incident radiation. The voltage level of the pixel voltage signal VPR continuously adapts to the intensity of the incident radiation at any point in time.

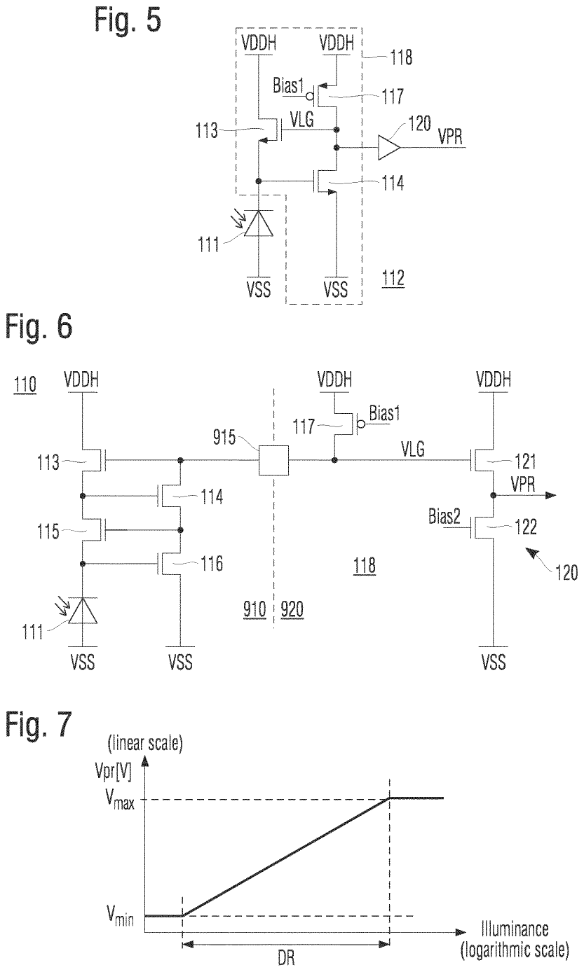

FIG. 5 and FIG. 6 show photoreceptor circuits 112 that include a logarithmic amplifier circuit (LAC) 118. The voltage level of the pixel voltage signal VPR logarithmically increases with linearly increasing intensity of the incident radiation.

The photoelectric conversion elements 111 of the photoreceptor circuits 112 include one or more photodiodes. Each of the photoreceptor circuits 112 includes an LAC 118 and a source follower circuit 120.

In FIG. 5, an anode of the photoelectric conversion element 111 is electrically connected to a reference potential VSS. The LAC 118 includes a main-stage feedback transistor 113 with a load path electrically connected between a positive pixel supply voltage VDDH and the cathode of the photoelectric conversion element 111. A pull-up transistor 117 with constantly biased gate and a load path of a main-stage amplifier transistor 114 are electrically connected in series between the positive pixel supply potential VDDH and the reference potential VSS. The gate of the main-stage amplifier transistor 114 is connected to the cathode of the photoelectric conversion element 111. The gate of the main-stage feedback transistor 113 is connected to an LAC output node between the pull-up transistor 117 and the main-stage amplifier transistor 114. The main-stage feedback transistor 113 and the main-stage amplifier transistor 114 may be n channel field effect transistors (nFETs). The pull-up transistor 117 may be a p channel field effect transistor (pFET).

The main-stage amplifier transistor 114 operates as an inverting amplifier for the first photocurrent. The main-stage feedback transistor 113 operates as a feedback element connected between an input and an output of the inverting amplifier. The inverting amplifier ensures that a voltage across the photoelectric conversion element 111 is approximately constant and independent from the incident radiation intensity. An output voltage VLG of the LAC 118 shows a logarithmic dependence on the photocurrent of the photoelectric conversion element 111.

The LAC output node is electrically connected to an input of a source follower circuit 120. The source follower circuit 120 outputs the pixel voltage signal VPR. The source follower circuit 120 forms a near-unity-gain voltage buffer that isolates the LAC 118 from electric circuits receiving the LAC output signal. The logarithmic characteristic of the radiation sensitive circuit 110 simplifies the comparison of the pixel voltage signal VPR with a reasonable gain threshold voltage for the change between the voltage levels of the gain control signal.

FIG. 6 shows an LAC 118 that includes a main-stage feedback transistor 113 and a pre-stage feedback transistor 115 with load paths electrically connected in series between the positive pixel supply voltage VDDH and the cathode of the photoelectric conversion element 111. Load paths of a pull-up transistor 117 with constantly biased gate, a main-stage amplifier transistor 114 and a pre-stage amplifier circuit 116 are electrically connected in series between the positive pixel supply potential VDDH and the reference potential VSS. The gate of the pre-stage amplifier transistor 116 is connected to the cathode of the photoelectric conversion element 111. The gate of the pre-stage feedback transistor 115 is connected to a network node between the main-stage amplifier transistor 114 and the pre-stage amplifier transistor 116. The gate of the main-stage amplifier transistor 114 is connected to a network node between the main-stage feedback transistor 113 and the pre-stage feedback transistor amplifier 115. The gate of the main-stage feedback transistor 113 is connected to an LAC output node between the pull-up transistor 117 and the main-stage amplifier transistor 114.

The main-stage feedback transistor 113, the main-stage amplifier transistor 114, the pre-stage feedback transistor 115, and the pre-stage amplifier transistor 116 may be nFETs. The pull-up transistor 117 may be a pFET. The LAC 118 with main stage and pre-stage can provide a higher gain than the LAC 118 without pre-stage illustrated in FIG. 5.

The source follower circuit 120 includes a source follower amplifier transistor 121 and a source follower load transistor 122 with constantly biased gate. Load paths of the source follower amplifier transistor 121 and the source follower load transistor 122 are electrically connected in series between the positive pixel supply potential VDDH and the reference potential VSS. The LAC output node is electrically connected to the gate of the source follower amplifier transistor 121. The source follower circuit 120 outputs the pixel voltage signal VPR. The source follower circuit 120 forms a near-unity-gain voltage buffer that isolates the LAC from electric circuits receiving the LAC output signal.

FIG. 7 shows the output characteristics of the radiation sensitive circuits 110 of FIG. 5 and FIG. 6. The graph shows the voltage level of the pixel voltage signal VPR as a function of the illuminance, where the scale of the abscissa axis is logarithmic and the scale of the ordinate axis is linear. The usable range for the pixel voltage signal VPR is between a minimum voltage Vmin given by the noise level and a maximum voltage Vmax given by the saturation voltage of the LAC. Due to the logarithmic transfer characteristic, the usable range for the pixel voltage signal VPR is converted to a high dynamic range DR over several orders of magnitude for the illuminance. The radiation sensitive circuit operates as a high dynamic range light meter that can efficiently control the gain of the active pixel circuits.

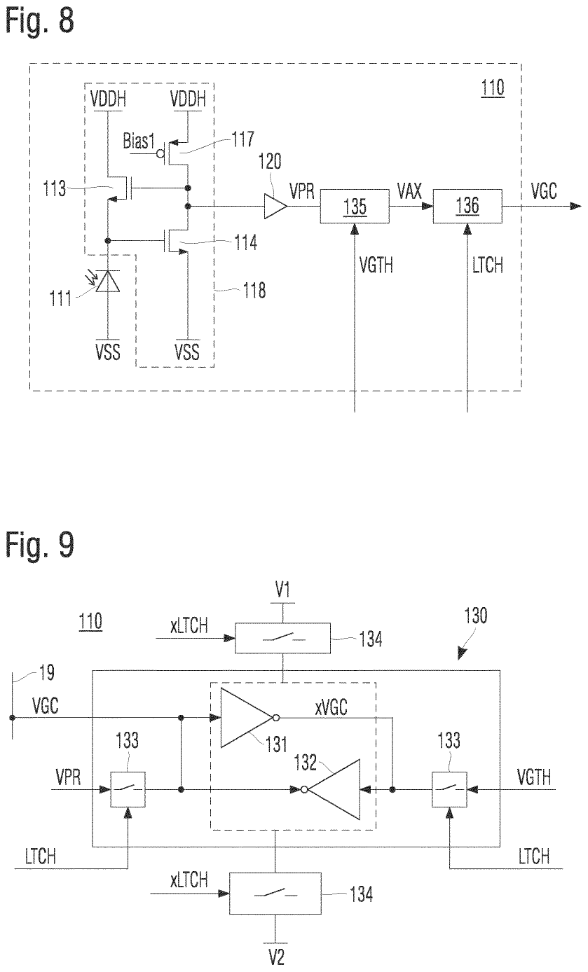

FIG. 8 shows a radiation sensitive circuit 110 that includes a light level judgement circuit 135. The light level judgement circuit 135 outputs an auxiliary signal VAX that has an active voltage level when a voltage level of the pixel voltage signal VPR is higher than a gain threshold voltage VGTH.

The gain threshold voltage VGTH may be a constant voltage or a programmable voltage. The gain threshold voltage VGTH may be generated in the macro pixel 100 or may be generated outside the macro pixel 100. For example, the vertical scanning unit 30 shown in FIG. 2 may generate a global gain threshold voltage VGTH and may supply the global gain threshold voltage VGTH to all macro pixels 100 of the pixel array 10. The light level judgement circuit 135 can include a comparator circuit, e.g., a high-gain differential amplifier circuit or a latch comparator circuit to compare the pixel voltage signal VPR with the gain threshold voltage VGTH.

The auxiliary signal VAX is a digital signal that changes between an active voltage level and an inactive voltage level. The auxiliary signal VAX can have an active voltage level when the voltage level of the pixel voltage signal VPR is not lower than the gain threshold voltage VGTH. The gain control signal VGC is derived from the auxiliary signal VAX. The gain control signal VGC can be a latched version of the inverted auxiliary signal xVAX or the non-inverted auxiliary signal VAX.

The radiation sensitive circuit 110 may include a latch circuit 136 that latches a result of a comparison of the pixel voltage signal VPR with a gain threshold voltage VGTH.

For example, the latch circuit 136 latches the auxiliary signal VAX output by the light level judgement circuit 135 in response to a latch control signal LTCH. The latch control signal LTCH is generated outside the macro pixel 100. For example, the vertical scanning unit 30 shown in FIG. 2 may generate latch control signals LTCH successively for each pixel row and may successively apply the latch control signals LTCH to all macro pixels 100 of the pixel array 10. According to another example, the vertical scanning unit 30 shown in FIG. 2 may generate a global row latch control signal LTCH and may supply the row latch control signal LTCH to all macro pixels 100 of the pixel array 10.

The latch circuit 136 may be an edge-triggered latch that latches the result of the comparison of the pixel voltage signal VPR in response to a transition of the latch control signal LTCH from an inactive level to an active level or vice versa. Once latched, the latch circuit 136 stores the voltage level of the gain control signal VGC long enough such that the gain control signal VGC does not change for a predefined period of time required for a stable operation of the active pixel circuits 180 controlled by the gain control signal VGC.

The predefined period of time may correspond to an exposure period in which the active pixel circuit accumulates electric charges generated by the incident radiation on a floating diffusion capacitor, or a transfer period in which previously accumulated electric charges are transferred to the floating diffusion capacitor. Latching the gain control signal enables a stable operation of the active pixel circuits with the same gain for a complete exposure of the active pixel circuit and/or a complete transfer of accumulated charge in the active pixel circuit.

The predefined period of time may end when a readout of the pixel output voltage is completed, e.g., with the end of the row readout period. For example, when a readout of a pixel circuit includes the reset of a floating diffusion region to a reset level, the analog-to-digital conversion of the reset level of the floating diffusion region, the transfer of the charge accumulated by the photoelectric conversion element in an exposure period to the floating diffusion, and the analog-to-digital conversion of the signal level of the floating diffusion region holding the accumulated charge, the gain control signal remains active for the complete period from beginning of the reset of the floating diffusion region until the end of the readout of the signal level or remains inactive for the complete period from beginning of the reset of the floating diffusion region until the end of the readout of the signal level. In particular, the gain control signal does not change between inactive and active in the row readout period.

FIG. 9 illustrates a radiation sensitive circuit 110 that includes a latch comparator circuit 130 configured to obtain the gain control signal VGC by comparing the pixel voltage signal VPR with a gain threshold voltage VGTH and latching a result of the comparison in response to a latch control signal LTCH.

The latch comparator circuit 130 includes a first inverter circuit 131 and a second inverter circuit 132, wherein the first inverter circuit 131 and the second inverter circuit 132 are in positive feedback.

The latch control signal LTCH may control a first switching assembly 133 to pass the pixel voltage signal VPR to an input of the first inverter circuit 131 and the gain threshold voltage VGTH to an input of the second inverter circuit 132 in a sample period, and to disconnect the input of the first inverter circuit 131 from the pixel voltage signal VRT and the input of the second inverter circuit 132 from the gain threshold voltage VGTH outside the sample period.

The inverted latch control signal LTCH may control a second switching assembly 134 to disconnect the first inverter circuit 131 and the second inverter circuit 132 from the positive pixel supply voltage VDDH and a reference potential VSS in the sample period, and to connect the first inverter circuit 131 and the second inverter circuit 132 between a positive pixel supply voltage VDDH and a reference potential VSS outside the sample period.

In the sample period, the pixel voltage signal VPR is applied to the input of the first inverter circuit 131, and the gain threshold voltage VGTH is applied to the input of the second inverter circuit 132. An output of the first inverter circuit 131 is connected to the input of the second inverter circuit 132. An output signal of the first inverter circuit 131 is applied to the input of the second inverter circuit 132. An output of the second inverter circuit 132 is connected to the input of the first inverter circuit 131. An output signal of the second inverter circuit 132 is applied to the input of the first inverter circuit 131.

The two inverter circuits 131, 132 in positive feedback form a simple latch structure that may include mainly or exclusively digital thin gate transistors. Each inverter circuit 131, 132 outputs a voltage representing the opposite logic level to its input and inverts the input signal applied. Each inverter circuit 131, 132 may include a single nFET and a resistive load, a single pFET and a resistive load or two complementary FETs in a CMOS configuration, by way of example.

The first switching assembly 133 may include a sample and hold circuit with a first part sampling the pixel voltage signal VPR on an output capacitance of the second inverter circuit 132 and with a second part sampling the gain threshold voltage VGTH on an output capacitance of the first inverter circuit 131.

The first part and the second part of the first switching assembly 133 may be matched. The first part and the second part may include matching components. For example, the first part and the second part may include transistors of the same channel type, e.g., nFETs with the same channel length and the same channel width, or pFETs with the same channel length and channel width. In particular, the first part and the second part may form a differential pair or may include a differential pair.

The second switching assembly 134 enables the latch comparator circuit 130 by passing a high potential V1 and/or a low potential V2 to appropriate sides of the load paths of the inverter circuits 131, 132. The second switching assembly 134 may disable the latch comparator circuit 130 by separating at least one side of the load paths of the inverter circuits 131, 132 from the low potential V2 and/or from the high potential V1.

The second switching assembly 134 may include one or more electronic switches. For example, the second switching assembly 134 includes one or more pFETs between the high potential V1 and high potential nodes of the load paths of the inverter circuits 131, 132 and/or may include one or more nFETs between low potential nodes of the load paths of the inverter circuits 131, 132 and the low potential V2.

The latch comparator circuit 130 inherently stores a comparison result and may be interfaced to a gain signal line 19 without any intermediate latch or memory cell. The latch comparator circuit 130 can directly output the latched gain control signal VGC to the gain signal line 19 that passes the gain control signal VGC to the active pixel circuits 180 of the same macro pixel 100.

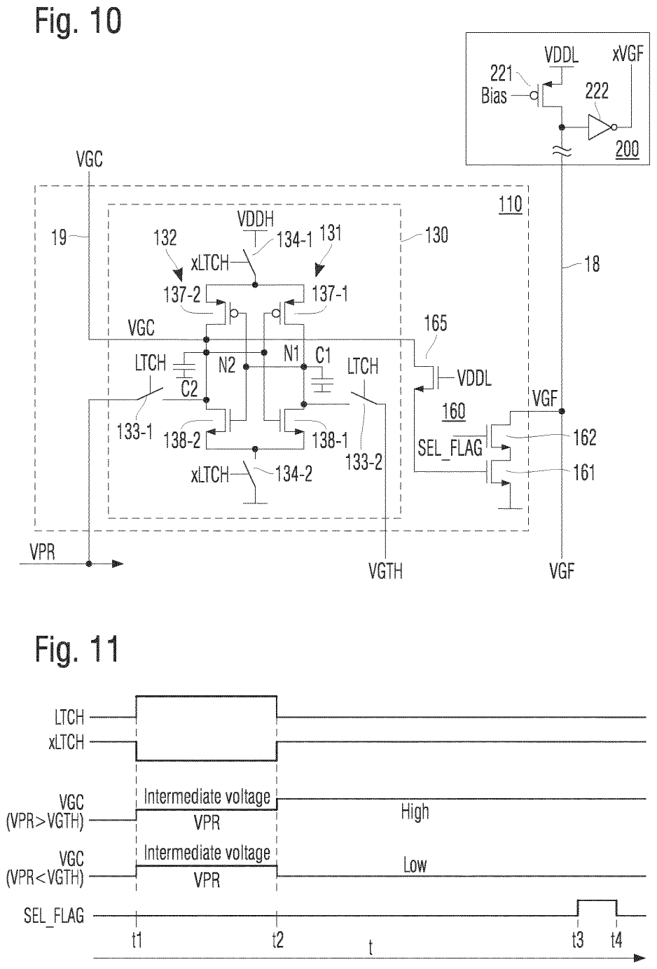

FIG. 10 shows a latch comparator circuit 130 with the first inverter circuit 131 and the second inverter circuit 132 based on CMOS converters.

The first inverter circuit 131 includes a first CMOS inverter with a first p channel transistor 137-1 and a first n channel transistor 138-1, wherein a load path of the first p channel transistor 137-1 and a load path of the first n channel transistor 138-1 are electrically connected in series between the positive pixel supply voltage VDDH and the reference potential VSS in this order. The first CMOS inverter has a first output capacitance C1 at a first inverter node N1 between the first p channel transistor 137-1 and the first n channel transistor 138-1.

The second inverter circuit 132 includes a second CMOS inverter with a second p channel transistor 137-2 and a second n channel transistor 138-2, wherein a load path of the second p channel transistor 137-2 and a load path of the second n channel transistor 138-2 are electrically connected in series between the positive pixel supply voltage VDDH and the reference potential VSS in this order. The second CMOS inverter has a second output capacitance C2 at a second inverter node N2 between the second p channel transistor 137-2 and the second n channel transistor 138-2. The first and second inverter circuits 131, 132 are in positive feedback. The latch comparator circuit 130 outputs the gain control signal VGC at the second inverter node N2, which is electrically connected to the gain signal line 19 of the macro pixel 100.

FIG. 11 shows voltage levels of the latch control signal LTCH, the inverted latch control signal, the gain control signal VGC for when the pixel voltage signal VPR exceeds the gain threshold voltage VGTH and the gain control signal VGC for when the pixel voltage signal VPR is less than the gain threshold voltage VGTH. The active level of the latch control signal LTCH is a digital high level. The active level of the inverted latch control signal LTCH is the digital low level.

A sample period starts at t=t1. The latch control signal LTCH and the inverted latch control signal xLTCH change from the inactive level to the active level. The active inverted latch control signal xLTCH turns off the switches 134-1, 134-2 of the second switching assembly 134 and separates the first inverter circuit 131 and the second inverter circuit 132 from the positive pixel supply voltage VDDH and the reference potential VSS.

The active latch control signal LTCH turns on the switches 133-1, 133-2 of the first switching assembly 133 to pass the pixel voltage signal VPR to the gates of the first p channel transistor 137-1 and the first n channel transistor 138-1, and to pass the gain threshold voltage VGTH to the gates of the second p channel transistor 137-2 and the second n channel transistor 138-2. The gain threshold voltage VGTH charges the first output capacitance C1. The pixel voltage signal VPR charges the second output capacitance C2 and the gain signal line 19. The voltage level of the gain control signal VGC is equal or approximately equal to the voltage level of the pixel voltage signal VPR.

The sample period ends at t=t2. The latch control signal LTCH and the inverted latch control signal xLTCH change from the active level to the inactive level. The inactive latch control signal LTCH turns off the switches 133-1, 133-2 of the first switching assembly 133 to disconnect the inputs of the first inverter circuit 131 and the second inverter circuit 132 and the first and second output capacitances C1, C2 from the pixel voltage signal VPR and the gain threshold voltage VGTH. The inactive inverted latch control signal xLTCH turns on the switches 134-1, 134-2 of the second switching assembly 134 to connect the first and second inverter circuits 131, 132 between the positive pixel supply voltage VDDH and the reference potential.

After a short relaxation time following t=t2, the voltages on the first and second inverter nodes N1, N2 reach stable states according to the voltages previously sampled on the first and second output capacitances C1, C2, wherein the inverter node with the initially higher voltage reaches a stable high state close to the positive pixel supply voltage VDDH and the inverter node with the initially lower voltage reaches a stable low state close to the reference potential VSS. Accordingly, the gain control signal VGH reaches a digital high level, when the pixel voltage signal VPR exceeds the gain threshold voltage VGTH, and a digital low level, when the pixel voltage signal VPR is less than the gain threshold voltage VGTH.

Referring again to FIG. 10, the radiation sensitive circuit 110 may further include a flag signal output circuit 160 configured to output a gain flag signal VGF containing information about a voltage level of the gain control signal VGC.

FIG. 10 refers to a column signal processing circuit 200 that includes a constant gate bias pull-up transistor 221 for connecting the flag signal line 18 to a positive logic supply voltage VDDL.

The flag signal output circuit 160 may include a flag output transistor 161 and a flag select transistor 162 electrically connected in series between the flag signal line 18 and the reference potential VSS. A flag select signal SEL_FLAG is applied to the gate of the flag select transistor 162 in a flag readout period. The gain control signal VGC or a signal derived from the gain control signal VGC is applied to the gate of the flag output transistor 161. The flag signal output circuit 160 can also be combined with a light level judgement circuit 135 and a latch circuit 136 as illustrated in FIG. 8.

Once the gain control signal VGC is latched, the gain control signal VGC has the high logic level or the low logic level. In each flag readout period, the flag select signal SEL_FLAG becomes active and turns on the flag select transistor 162. A voltage level of the gain flag signal VGF transmitted on the flag signal line 18 changes to the logic low level only when the voltage level of the gain control signal VGC is logic high and the flag select signal SEL_FLAG is active.

The gain control signal VGC may be directly applied to the gate of the flag output transistor 161 when the positive pixel supply voltage VDDH and the positive logic supply voltage VDDL are equal or approximately equal. Otherwise, the flag signal output circuit 160 may include a level shift transistor 165, wherein a source-to-drain path of the level shift transistor 165 is electrically connected between an output of the latch comparator circuit 130 and the gate of the flag output transistor 161, and wherein a logic high level for the positive logic supply voltage VDDL is applied to the gate of the level shift transistor 165.

The column signal processing circuit 200 may be configured to receive the gain flag signal VGF and to compile digital pixel data based on the gain flag signal VGF and the pixel output voltage a of the active pixel circuit 180.

The column signal processing circuit 200 may further include an inverter circuit 222 for compensating the signal inversion through the flag signal output circuit 160 and for obtaining a logic high signal indicating an active gain flag signal VGF.

FIG. 11 shows the active row flag select signal SEL_FLAG in a flag readout period between t=t3 and t=t4 for obtaining information about the logic level of the gain control signal VGC used by the active pixel circuits of the concerned macro pixel in the pertinent exposure period.

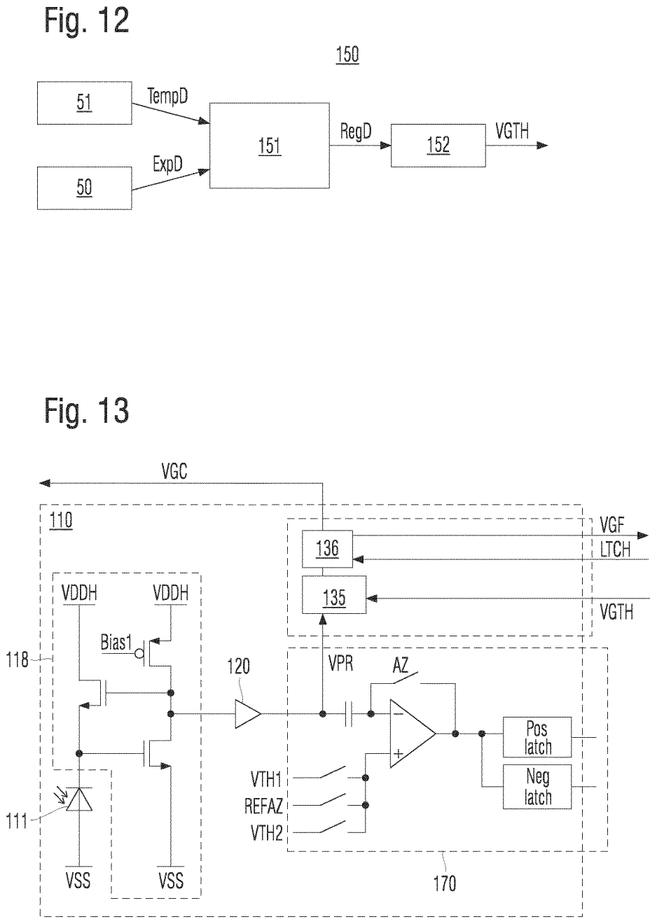

FIG. 12 shows a threshold defining circuit 150 configured to generate the gain threshold voltage VGTH as a function of a temperature and/or selected exposure time.

The threshold defining circuit 150 includes a memory unit 151 and a programmable voltage generator 152. The memory unit 151 includes a plurality of entries and outputs register setting data RegD in response to temperature data TempD and exposure setting data ExpD. For example, the memory unit 151 may include a look-up table, wherein each entry of the look-up table is selectable by an address derived from the temperature data TempD and/or exposure setting data ExpD, and wherein each entry contains suitable register setting data RegD for the programmable voltage generator 152. The entries of the look-up table can be defined in a wafer test phase and/or by user settings. The programmable voltage generator 152 receives the register setting data RegD and outputs the gain threshold voltage VGTH, wherein the voltage level of the gain threshold voltage VGTH is determined by the received register setting data RegD.

The temperature data TempD may be provided by a thermometer circuit 51 that measures a temperature of a part of the solid-state imaging device 90 and/or may be supplied through a data interface of the solid-state imaging device. The exposure date ExpD may include the exposure time used for the next image capture by the active pixel circuits and may be provided by the sensor controller 50.

The threshold defining circuit 150 enables dynamic adjustment of the gain threshold voltage VGTH to the set exposure time and to the temperature of the image sensor. For example, at higher temperatures, the gain threshold voltage VGTH may be reduced to compensate for a temperature dependence of the pixel voltage signals VPR of the radiation sensitive circuits 110. For longer exposure times, the gain threshold voltage VGTH may be reduced to compensate for the expected higher pixel output voltages VSL of the active pixel circuits 180.

A radiation sensitive circuit as described with reference to the preceding illustrations may be exclusively provided for controlling the gain of the active pixel circuits of a macro pixel.

In FIG. 13, the radiation sensitive circuit 110 further includes an event detection circuit 170 configured to output an active event signal when a change of the pixel voltage signal VPR exceeds a predefined threshold voltage for event detection.

The event detection circuit 170 may output an active ON event signal, when an increase of the pixel voltage signal VPR exceeds a predefined first threshold voltage VTH1. The event detection circuit 170 may output an active OFF event signal, when a decrease of the pixel voltage signal VPR exceeds a predefined second threshold voltage VTH2.

The event detection circuit 170 delivers information about changes in the incident radiation intensity. Event data obtained from the ON event signals and OFF event signals can be directly linked to motion and/or changing illumination conditions.

The event detection circuit 170 may include a single comparator sequentially comparing a differential voltage derived from the current radiation intensity and a previous radiation intensity to the first threshold voltage VTHI to check for ON events and to the second threshold voltage VTH2 to check for OFF events. Alternatively, the event detection circuit 170 may include a capacitive amplifier feeding two parallel comparators that can simultaneously test for ON events and for OFF events.

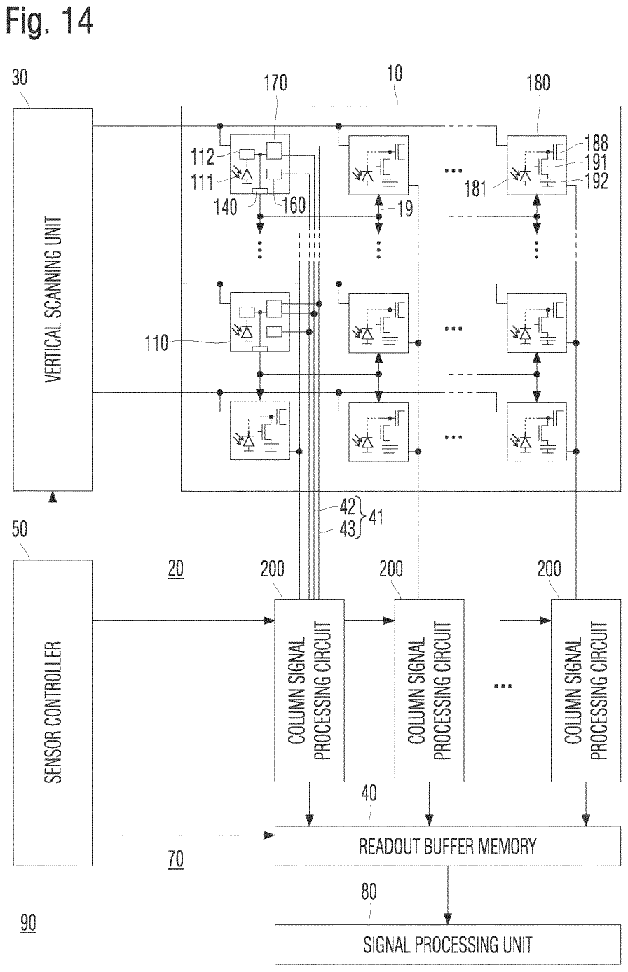

The solid-stage imaging device in FIG. 14 includes macro pixels 100 with radiation sensitive circuits 110 that include event detection circuits 170 for continuous row-by-row event readout.

An event data bus 41 may include a common data line for transmitting the ON events and the OFF events by different signal levels or in a time multiplex scheme. In the illustrated embodiment, the event data bus 41 includes a first data line 42 for transmitting the ON events and a second data line 43 for transmitting the OFF events. For transmitting an ON event, an ON event signal transmitted on the first data line 42 has an active level. For transmitting an OFF event, an OFF event signal transmitted on the second data line 43 has an active level.

The column signal processing unit 200 receives the event data from all macro pixels 100 of the selected pixel group via the event data bus 41, and the group address(es) of the selected pixel group from which the received event data originates. From the group address and identifiers of the event data buses 41 transmitting event data, the column signal processing unit 200 may compile a digital address event representation AER for each event. The AER includes the group address, a column address derived from the identifiers of the event data busses transmitting events, the event data, and, if applicable, a time stamp. The column signal processing unit 200 outputs the AERs to the readout buffer memory 40. Alternatively, the vertical scanning unit 30 may readout the radiation sensitive circuits 110 in a synchronous scheme row-by-row, and the readout buffer memory compiles the AER information based on the received ON events and OFF events and information identifying the respective pixel rows.

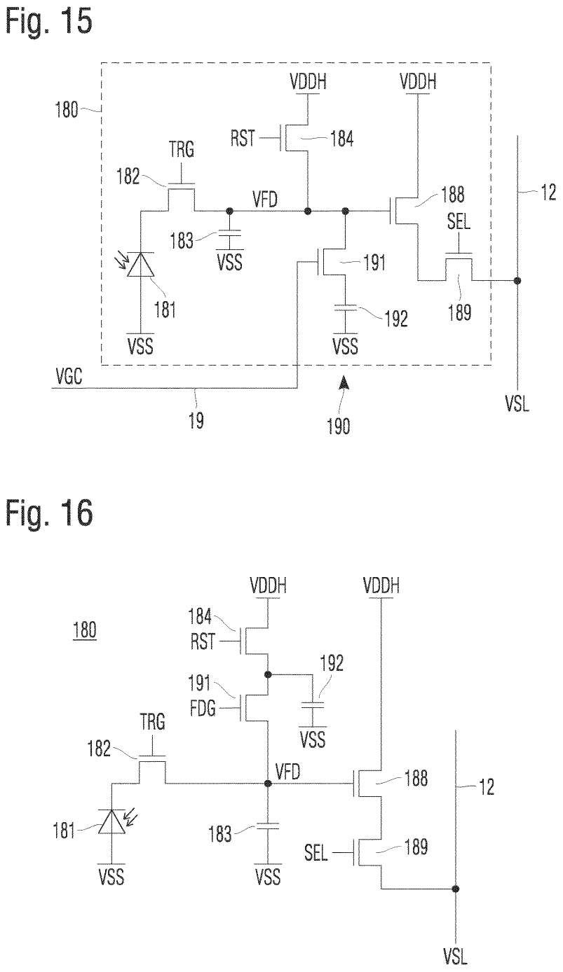

FIG. 15 and FIG. 16 illustrate examples of active pixel circuits 180 suitable to be combined with any of the radiation sensitive circuits 110 as described above.

Each active pixel circuit 180 may include a control element 190 configured to change between a first state and a second state in response to the gain control signal VGC, wherein when the control element 190 is in the first state a conversion gain of the active pixel circuit 180 is higher than when the control element 190 is in the second stage.

The control element 190 may be or include a transistor that controls a capacitance used for temporary storage of the electric charge accumulated in an exposure period, wherein the controlled capacitance may be high when the transistor is on, and is low when the transistor is off, or vice versa. Alternatively, the control element 190 may be an electric element shifting a capacitor reference potential for a capacitive structure that stores the electric charge accumulated in the exposure period, wherein the capacitor reference potential may be low in a first state of the electric element and high in a second state of the electric element.

For example, the active pixel circuit 180 may include a floating diffusion capacitor 183 configured to store electric charge obtained by integrating the second photocurrent, and the control element 190 includes a floating diffusion transistor 191 configured to switch a supplementary capacitive structure 192 in parallel with the floating diffusion capacitor 183 in response to the gain control signal VGC.

For the rest, the active pixel circuit 180 may be any active pixel circuit capable of integrating a photocurrent generated by incident radiation over an exposure period and converting the integration result into an analog pixel output voltage VSL.

FIG. 15 shows an example of an active pixel circuit 180 with five transistors in combination with one second photoelectric conversion element 181. Each of the transistors is or includes an nFET.

The photoelectric conversion element 181 of the active pixel circuit 180 may be a photodiode photoelectrically converting incident electromagnetic radiation into electric charges. The amount of electric charge generated in the second photoelectric conversion element 181 corresponds to the intensity of the incident electromagnetic radiation. The photoelectric conversion element 181 may include or consist of a photodiode which converts electromagnetic radiation incident on a detection surface into the second photocurrent by means of the photoelectric effect. The electromagnetic radiation may include visible light, infrared radiation and/or ultraviolet radiation. The amplitude of the photocurrent corresponds to the intensity of the incident electromagnetic radiation, wherein in the intensity range of interest the second photocurrent increases approximately linearly with increasing intensity of the detected electromagnetic radiation.

A load path of a transfer transistor 182 is electrically connected between a cathode of the photoelectric conversion element 181 of the active pixel circuit 180 and a first electrode of a floating diffusion capacitor 183. The transfer transistor 182 serves as transfer element for transferring charge from the photoelectric conversion element 181 of the active pixel circuit 180 to the first electrode of the floating diffusion capacitor 183 in a transfer period. The floating diffusion capacitor 183 serves as temporary local charge storage. A transfer signal TRG is supplied to the gate (transfer gate) of the transfer transistor 182 through a transfer control line. The transfer signal TRG changes between an active signal level (“active transfer signal”) and an inactive signal level (“inactive transfer signal”). In response to an active transfer signal TRG, the transfer transistor 182 transfers electrons photoelectrically converted by the photoelectric conversion element 181 of the active pixel circuit 180 to the first electrode of the floating diffusion capacitor 183. In the illustrated embodiment, the active signal level is the high level.

A first electrode of a floating diffusion capacitor 183 stores the electric charge supplied from the second photoelectric conversion element 181 in a transfer period. The first electrode of the floating diffusion capacitor 183 may be a floating diffusion region. A floating diffusion voltage VFD of the first electrode of the floating diffusion capacitor 183 depends on the state of the active pixel circuit 180: In a reset phase, the floating diffusion voltage VFD is a function of the pixel dark current representing the noise. In a data phase, the floating diffusion voltage VFD is a function of the brightness (illumination intensity) sampled by the photoelectric conversion element 181 of the active pixel circuit 180.

A load path of an FD reset transistor 184 is connected between the positive pixel supply voltage VDDH and the first electrode of the floating diffusion capacitor 183. The FD reset transistor 184 serves as a reset element that resets the floating diffusion potential VFD at the gate of the amplifier transistor 188. A pixel reset signal RST is supplied to the gate of the reset transistor 184 through a reset control line. The pixel reset signal RST changes between an active signal level (“active pixel reset signal”) and an inactive signal level (“inactive pixel reset signal”). In the illustrated embodiment, the active signal level is the high level. An active pixel reset signal RST sets the floating diffusion potential VFD equal to or approximately equal to the positive pixel supply voltage VDDH. Alternatively, the FD reset transistor 184 may connect the floating diffusion potential VFD to a pixel reset voltage different from the positive pixel supply voltage VDDH.

An amplifier transistor 188 is in a source follower configuration, wherein the controlled load path of the amplifier transistor 188 is electrically connected between the positive pixel supply voltage VDDH and the data signal line 12. The first electrode of the floating diffusion capacitor 183 is connected to the gate of the amplifier transistor 188. A potential at the gate of the amplifier transistor 188 is equal to the floating diffusion voltage VFD. The first electrode of the floating diffusion capacitor 183 functions as the input node of the amplifier transistor 188.

A load path of a select transistor 189 is electrically connected in series between the amplifier transistor 188 and the data signal line 12. The select transistor 189 connects the amplifier transistor 188 to the data signal line 12 in a row readout period. A select signal SEL is supplied to the gate of the select transistor 189 through a select line. The select signal SEL changes between an active signal level (“active row select signal”) and an inactive signal level (“inactive row select signal”). In the illustrated embodiment, the active signal level is the high level.

A load path of a floating diffusion transistor 191 is connected between the first electrode of the floating diffusion capacitor 183 and a first electrode of a supplementary capacitive structure 192. A second electrode of the supplementary capacitive structure 192 is connected to the reference potential VSS. The gain control signal VGC is supplied to a gate of the floating diffusion transistor 191 through a gain signal line 19. The gain control signal VGC changes between an active signal level (“active gain control signal”) and an inactive signal level (“inactive gain control signal”). In the illustrated embodiment, the active signal level is the high level.

When an active gain control signal VGC turns on the floating diffusion transistor 191, the capacitance of the supplementary capacitive structure 192 adds to the capacitance of the floating diffusion capacitor 183. A comparatively high amount of electric charge can be transferred to and from the gate of the amplifier transistor 188 such that even under bright illumination conditions the total capacitance is not completely discharged and the dynamic range is high.

When an inactive gain control signal VGC turns off the floating diffusion transistor 191, the supplementary capacitive structure 192 is decoupled from the floating diffusion capacitor 183. Even a small amount of accumulated charge results in a comparatively high voltage signal swing at the gate of the amplifier transistor 188 under dark illumination conditions.

The gates of the transfer transistors 182, the gates of the FD reset transistors 184, and the gates of the select transistors 189 may each be connected for groups of active pixel circuits 180, e.g., pixel rows, such that the operations for each of the active pixel circuits 180 of one group of pixel circuits 180, e.g., one pixel row are performed simultaneously.

FIG. 16 shows an example with the load path of the floating diffusion transistor 191 electrically connected between the load path of the FD reset transistor 184 and the first electrode of the floating diffusion capacitor 183.

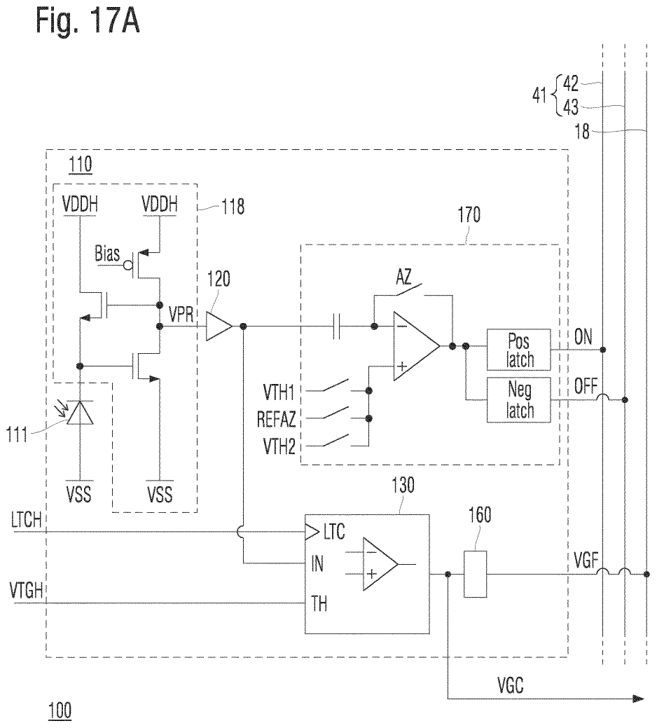

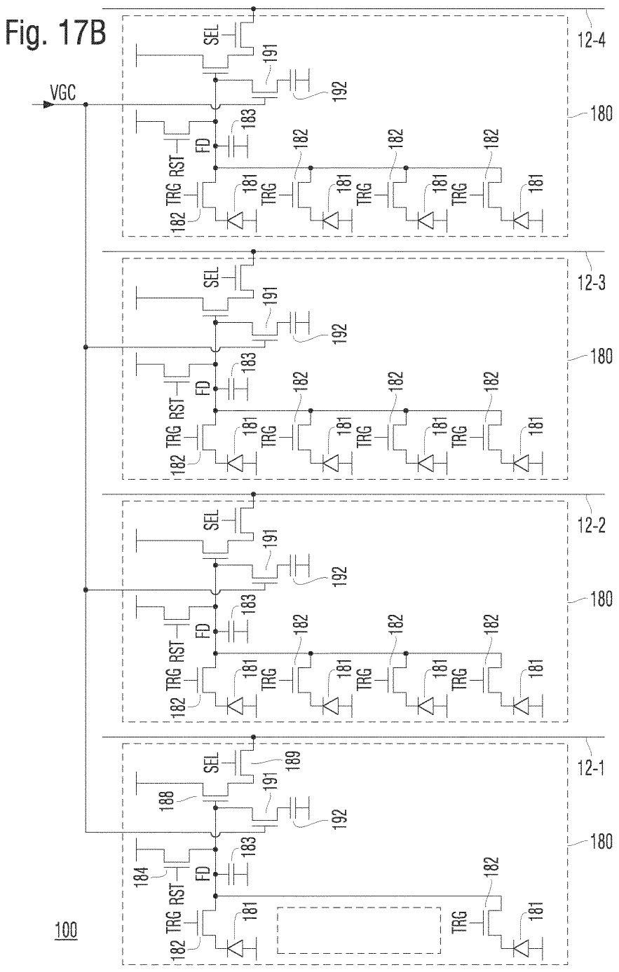

FIG. 17A and FIG. 17B concern the same macro pixel 100 that includes one radiation sensitive circuit 110 and a plurality of active pixel circuits 180, wherein the radiation sensitive circuit 110 includes a first photoelectric conversion element 111 that generates a first photocurrent, and wherein each active pixel circuit 180 includes a second photoelectric conversion element 181 configured to generate a second photocurrent. The active pixel circuits 180 of the macro pixel 100 receive the gain control signal VGC output from the radiation sensitive circuit 110 of the macro pixel 100.

In the illustrated embodiment, the radiation sensitive circuit 110 includes a single first photoelectric conversion element 111, a photoreceptor circuit 112 with a LAC 118 and a source follower circuit 120, a latch comparator circuit 130 and an event detection circuit 170.

The illustrated macro pixel 100 further includes four active pixel circuits 180. Three of the active pixel circuits 180 include four separated second photoelectric conversion elements 181 and a fourth active pixel circuit 180 includes two separated second photoelectric conversion elements 181. Each separated second photoelectric conversion element 181 is connectable to a first electrode of a floating diffusion capacitor 183 through a separate transfer transistor 182.

Each of the active pixel circuits 180 includes a floating diffusion transistor 191 and a supplementary capacitive structure 192. The gain control signal VGC output by the radiation sensitive circuit 110 is applied to the gates of the floating diffusion transistors 191 of all active pixel circuits 180 of the macro pixel 100.

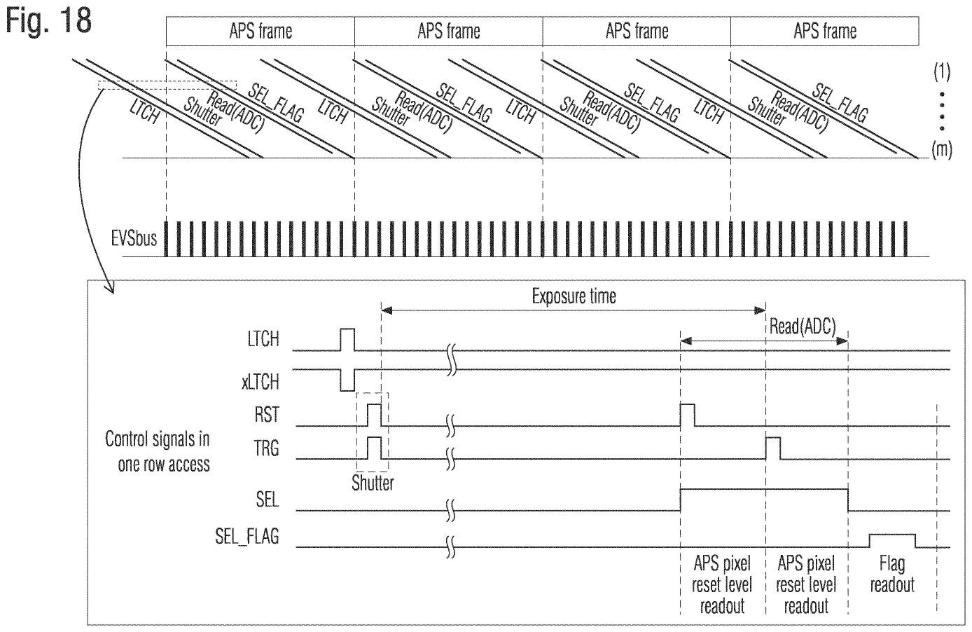

The upper part of FIG. 18 schematically shows a row-by-row readout of the active pixel circuits 180 of a solid-state imaging device. The readout of a complete frame starts with the readout of a first pixel row (1) and ends with a readout of the m-th pixel row (m).

The lower part of FIG. 18 shows the input signals of a macro pixel for the pixel readout of one of the m pixel rows. A gain control signal VGC for the pixel row is latched by turning on and off the latch control signal LTCH for the pixel row prior to starting the exposure period for the pixel row, wherein in the illustrated embodiment the exposure period starts at the end of a shutter operation resetting the floating diffusion potential and the cathode voltage of the photoelectric conversion element by an active reset signal RST and a coincident active transfer signal TRG. The row readout period starts with a further active reset signal RST selectively resetting the floating diffusion potential for obtaining the pixel reset level (P phase) and with a select signal SEL becoming active. The readout of the pixel reset level can overlap with the exposure period. The exposure period and the readout of the pixel reset level end with an active transfer signal TRG re-connecting the cathode of the photoelectric conversion element with the first electrode of the floating diffusion capacitor to transfer the accumulated charge to the floating diffusion capacitor. The readout of the pixel data level (D phase) follows the exposure period. The row readout period ends with the select signal SEL becoming inactive.

The flag readout period for reading out the gain flag signal VGF can follow at any time after the LTCH pulse. In the embodiment shown, the flag readout period directly follows the row readout period.

FIG. 18 further shows the readout of the event signals, which may be synchronous or asynchronous to the readout of the active pixel circuits.

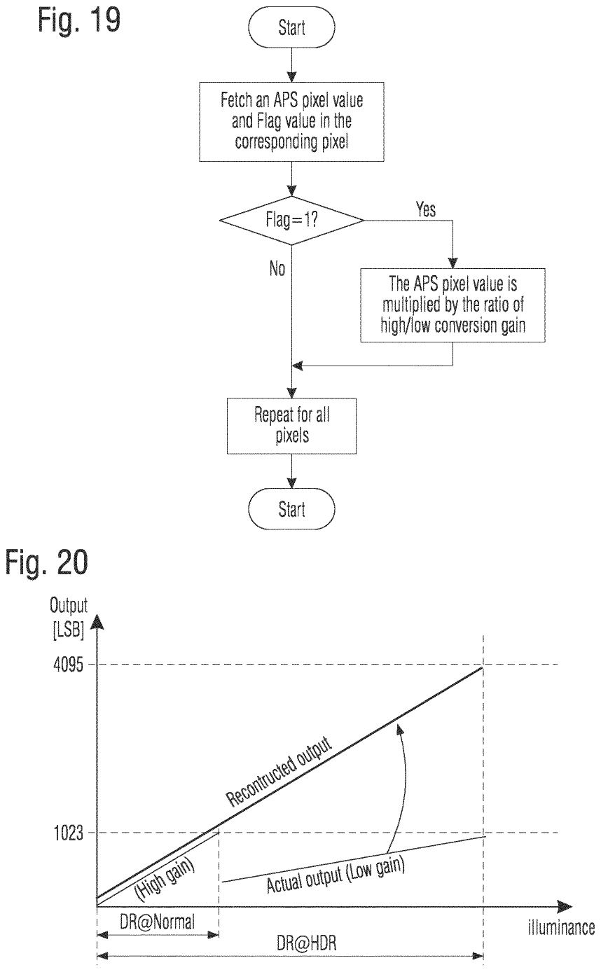

FIG. 19 illustrates the operations to obtain the final digital pixel values of a single HDR image. The operation can be carried out by an arithmetic logic unit of the column signal processing circuits 200. The arithmetic logic unit receives the gain flag signal and the digital pixel values for the D phase and the P phase. When the gain flag signal indicates that the low conversion gain is used, the digital pixel values for the D phase and the P phase, or the corrected digital pixel value are multiplied with a correction factor given by the ratio between the high conversion gain and the low conversion gain. The operation is repeated for all pixels of the pixel column from which the arithmetic logic unit receives the digital pixel values and the gain flag signal.

FIG. 20 shows the effect of the operation described with respect to FIG. 19 with respect to the dynamic range of the active pixel circuits, wherein the correction factor is equal 4.

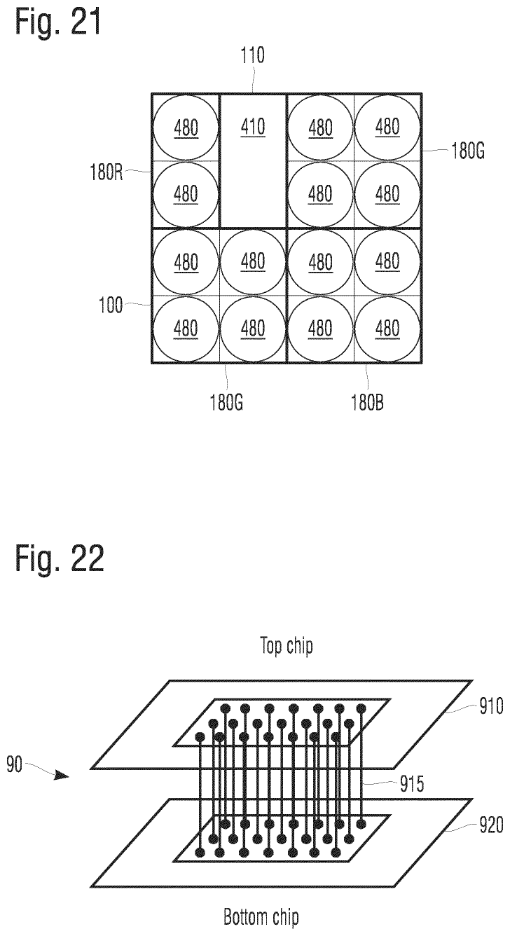

FIG. 21 refers to a pixel array, wherein the active pixel circuits 180 of each macro pixel 100 include at least one red pixel circuit 180R configured to detect red light, at least one green pixel circuit 180G configured to detect green light, and at least one blue pixel circuit 180B configured to detect blue light.

In the illustrated embodiment, the radiation sensitive circuit 110 includes an event detector circuit, and two green pixel circuits 180G. The red pixel circuit 180R may include two second photoelectric conversion elements. Each of the two green pixel circuits 180G and the blue pixel circuit 180B include four second photoelectric conversion elements as illustrated in FIG. 17B.

The outline of an area including the first detector region 410 of the photoelectric conversion element of the radiation sensitive circuit 110 and the second detector regions 480 of the photoelectric conversion elements of the active pixel circuits 180R, 180B, 180G forms a square. All detector regions 410, 480 within the square are assigned to the same macro pixel 100.

FIG. 22 is a perspective view showing an example of a laminated structure of a solid-state imaging device 90 with a plurality of pixels arranged matrix-like in array form. Each pixel includes a pixel circuit with at least one photoelectric conversion element.

The solid-state imaging device 90 has the laminated structure of a first chip (upper chip) 910 and a second chip (lower chip) 920. The laminated first and second chips 910, 920 may be electrically connected to each other through copper-to-copper bonds and/or TC(S)Vs (Through Contact (Silicon) Vias) formed in the first chip 910. The solid-state imaging device 90 may be formed to have the laminated structure in such a manner that the first and second chips 910 and 920 are bonded together at wafer level and cut out by dicing.

In the laminated structure of the upper and lower two chips, the first chip 910 may be an analog chip (sensor chip) including at least one analog component of each pixel circuit, e.g., the photoelectric conversion elements arranged in array form.

For example, the first chip 910 may include the active pixel circuits 180 and the photoelectric conversion elements 111 and the nFETs of the LACs 118 of the radiation sensitive circuits 110 as illustrated in FIG. 6. Alternatively, the first chip 910 may include further elements of the radiation sensitive circuits 110.

The second chip 920 may be mainly a logic chip (digital chip) that includes the elements complementing the elements on the first chip 910 to complete radiation sensitive circuits. The second chip 920 may also include analog circuits, for example circuits that quantize analog signals transferred from the first chip 910 through the TCVs. For example, the second chip 920 may include all or at least some of the components of the column signal processing circuits 200 as described above.

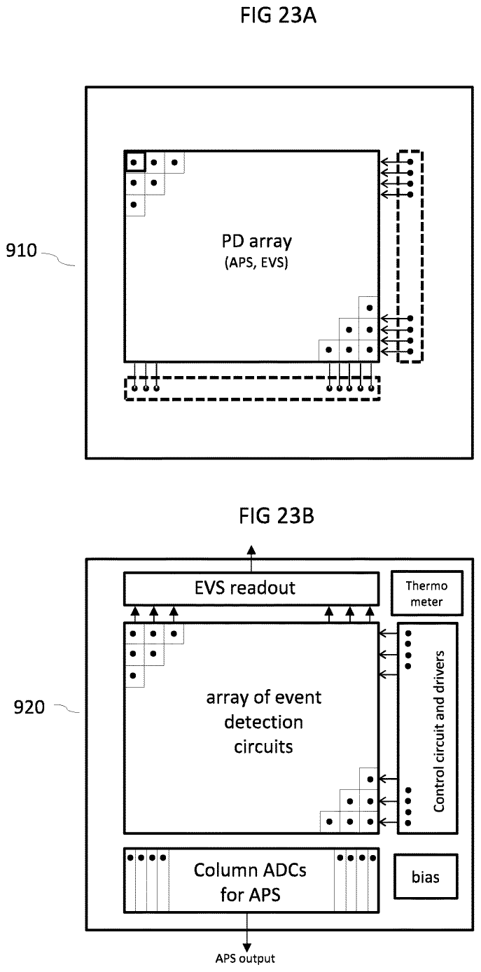

FIG. 23A shows an example for the top chip 910 of FIG. 22 and FIG. 23B shows the corresponding bottom chip 920.

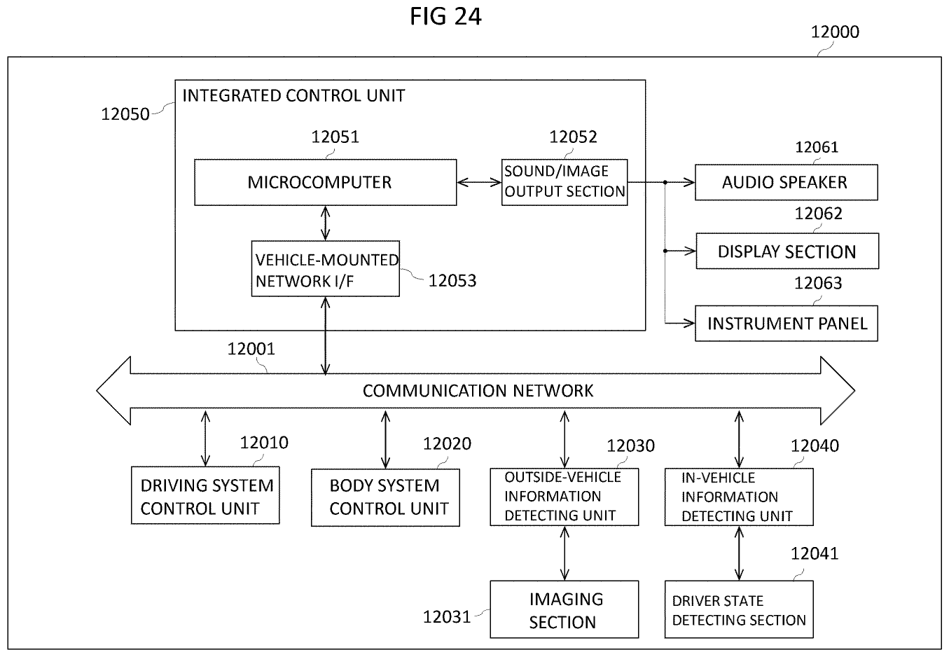

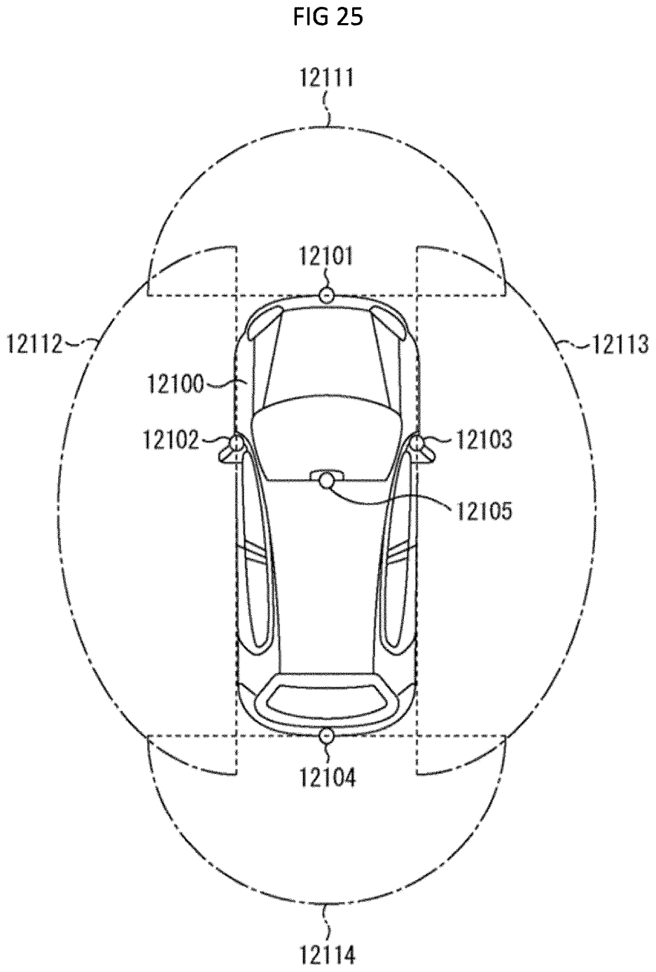

FIG. 24 is a block diagram depicting an example of schematic configuration of a vehicle control system 12000 as an example to which the technology according to the embodiments of the present disclosure can be applied.

The vehicle control system 12000 includes a plurality of electronic control units connected to each other via a communication network 12001. In the example depicted in FIG. 24, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 imaging an image of the outside of the vehicle and receives the imaged image. Based on the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 may be or may include a HDR solid-state imaging device of the present disclosure. The light received by the imaging section 12031 may be visible light or may be invisible light such as infrared rays or the like.

The in-vehicle information detecting unit 12040 detects information about the inside of the vehicle and may be or may include a HDR solid-state imaging device according to the embodiments of the present disclosure.

The in-vehicle information detecting unit 12040 is, for example, connected with a driver state detecting section 12041 that detects the state of a driver. The driver state detecting section 12041, for example, includes a camera that includes the solid-state imaging device and that is focused on the driver. Based on detection information input from the driver state detecting section 12041, the in-vehicle information detecting unit 12040 may calculate a degree of fatigue of the driver or a degree of concentration of the driver or may determine whether the driver is dozing.

The microcomputer 12051 can calculate a control target value for the driving force generating device, the steering mechanism, or the braking device based on the information about the inside or outside of the vehicle which information is obtained by the outside-vehicle information detecting unit 12030 or the in-vehicle information detecting unit 12040 and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automatic driving, which makes the vehicle to travel autonomously without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 based on the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound or an image to an output device capable of visually or audible notifying information to an occupant of the vehicle or the outside of the vehicle. In the example of FIG. 24, an audio speaker 12061, a display section 12062, and an instrument panel 12063 are illustrated as the output device. The display section 12062 may, for example, include at least one of an on-board display or a head-up display, wherein each of them may include a solid-state imaging device with CS pixel circuits using a capacitive current source as described with reference to the preceding Figures.

FIG. 25 is a diagram depicting an example of the installation position of the imaging section 12031, wherein the imaging section 12031 may include imaging sections 12101, 12102, 12103, 12104, and 12105.

The imaging sections 12101, 12102, 12103, 12104, and 12105 are, for example, disposed at positions on a front nose, side-view mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the side view mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 25 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the side view mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements each imaging element having pixels for phase difference detection, or may include a ToF module based on active pixel circuits with controllable gain according to the present disclosure.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance and perform automatic brake control (including following stop control), automatic acceleration control (including following start control), or the like. It is thus possible to perform cooperative control intended for automatic driving that makes the vehicle travel autonomously without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062 and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

The example of the vehicle control system to which the technology according to an embodiment of the present disclosure is applicable has been described above. By applying a HDR solid-state imaging device with active pixel circuits having a controllable gain according to the present disclosure, motion artefacts may be avoided, and frame rate may be improved. For example, recognition of pedestrians can be performed with higher frame rate and less motion artefacts.

Additionally, embodiments of the present technology are not limited to the above-described embodiments, but various changes can be made within the scope of the present technology without departing from the gist of the present technology.

A HDR solid-state imaging device including active pixel sensors with controlled gain in accordance with the present disclosure may be any device used for analyzing and/or processing radiation such as visible light, infrared light, ultraviolet light, and X-rays. For example, the HDR solid-state imaging device may be any electronic device in the field of traffic, the field of home appliances, the field of medical and healthcare, the field of security, the field of beauty, the field of sports, the field of agriculture, the field of image reproduction or the like.

Specifically, in the field of image reproduction, the HDR solid-state imaging device may be a device for capturing an image to be provided for appreciation, such as a digital camera, a smart phone, or a mobile phone device having a camera function. In the field of traffic, for example, the HDR solid-state imaging device may be integrated in an in-vehicle sensor that captures the front, rear, peripheries, an interior of the vehicle, etc. for safe driving such as automatic stop, recognition of a state of a driver, or the like, in a monitoring camera that monitors traveling vehicles and roads, or in a distance measuring sensor that measures a distance between vehicles or the like.

In the field of home appliances, the HDR solid-state imaging device may be integrated in any type of sensor that can be used in devices provided for home appliances such as TV receivers, refrigerators, and air conditioners to capture gestures of users and perform device operations according to the gestures. Accordingly, the HDR solid-state imaging device may be integrated in home appliances such as TV receivers, refrigerators, and air conditioners and/or in devices controlling the home appliances. Furthermore, in the field of medical and healthcare, the HDR solid-state imaging device may be integrated in any type of sensor provided for use in medical and healthcare, such as an endoscope or a device that performs angiography by receiving infrared light.

In the field of security, the HDR solid-state imaging device can be integrated in a device provided for use in security, such as a monitoring camera for crime prevention or a camera for person authentication use. Furthermore, in the field of beauty, the HDR solid-state imaging device can be used in a device provided for use in beauty, such as a skin measuring instrument that captures skin or a microscope that captures a probe. In the field of sports, the HDR solid-state imaging device can be integrated in a device provided for use in sports, such as an action camera or a wearable camera for sport use or the like. Furthermore, in the field of agriculture, the HDR solid-state imaging device can be used in a device provided for use in agriculture, such as a camera for monitoring the condition of fields and crops.

The present technology can also be configured as described below:

[1] A solid-state imaging device (90), including: a radiation sensitive circuit (110) configured to continuously convert a first photocurrent generated by incident radiation into a pixel voltage signal and outputs a gain control signal based on a voltage level of the pixel voltage signal; and an active pixel circuit (180) configured to integrate a second photocurrent generated by incident radiation in an exposure period and convert a resulting electric charge into a pixel output voltage at a conversion gain controllable by the gain control signal.

[2] The solid-state imaging device according [1], wherein the radiation sensitive circuit (110) includes a first photoelectric conversion element (111) configured to generate the first photocurrent from radiation incident in a first detector region (410), and wherein the active pixel circuit (180) includes a second photoelectric conversion element (181) configured to generate the second photocurrent from radiation incident in a second detector region (480) neighboring the first detector region (410).

[3] The solid-state imaging device according to any of [1] and [2], wherein the radiation sensitive circuit (110) includes a first photoelectric conversion element (111) configured to generate the first photocurrent and a photoreceptor circuit (112) configured to convert the first photocurrent into the pixel voltage signal.

[4] The solid-state imaging device according to [3], wherein the photoreceptor circuit (112) includes a logarithmic amplifier circuit (118).

[5] The solid-state imaging device according to any of [1] to [4], wherein the radiation sensitive circuit (110) includes a light level judgement circuit (135) configured to output an auxiliary signal, wherein the auxiliary signal has an active voltage level when a voltage level of the pixel voltage signal is higher than a gain threshold voltage.

[6] The solid-state imaging device according to [5], wherein the radiation sensitive circuit (110) includes a latch circuit (136) configured to latch a result of a comparison between the pixel voltage signal and the gain threshold voltage to obtain the gain control signal.

[7] The solid-state imaging device according to any of [1] to [6], wherein the radiation sensitive circuit (110) includes a latch comparator circuit (130) configured to obtain the gain control signal by comparing the pixel voltage signal with a gain threshold voltage and latching a result of the comparison in response to a latch control signal.

[8] The solid-state imaging device according to [5], further including: a threshold defining circuit (150) configured to generate the gain threshold voltage as a function of a temperature and/or selected exposure data.

[9] The solid-state imaging device according to any of [1] to [8], further including: a flag signal output circuit (160) configured to output a gain flag signal containing information about a voltage level of the gain control signal on a gain signal line (18).

[10] The solid-state imaging device according to [9], further including: a column processing circuit (200) configured to receive the gain flag signal and to compile digital pixel data based on the gain flag signal and the pixel output voltage of the active pixel circuit (180).

[11] The solid-state imaging device according to any of [1] to [10], an event detection circuit (170) configured to output an active event signal, when a change of the pixel voltage signal exceeds a predefined upper threshold voltage for event detection.

[12] The solid-state imaging device according to any of [1] to [11], wherein the active pixel circuit (180) includes a control element (190) configured to change between a first state and a second state in response to the gain control signal, and wherein when the control element (190) is in the first state a conversion gain of the active pixel circuit (180) is higher than when the control element (190) is in the second stage.

[13] The solid-state imaging device according to [12], wherein the active pixel circuit (180) includes a floating diffusion capacitor (183) configured to store electric charge obtained by integrating the second photocurrent, and wherein the control element (190) includes a floating diffusion transistor (191) configured to switch a supplementary capacitive structure (192) in parallel with the floating diffusion capacitor (183) in response to the gain control signal.

[14] The solid-state imaging device according to any of [1] to [13], wherein a macro pixel (100) includes one radiation sensitive circuit (110) and a plurality of active pixel circuits (180), wherein the radiation sensitive circuit (110) includes a first photoelectric conversion element (111) configured to generate the first photocurrent, and wherein each active pixel circuit (180) includes a second photoelectric conversion element (181) configured to generate the second photocurrents, and wherein the active pixel circuits (180) of the macro pixel (100) receive the gain control signal output from the radiation sensitive circuit (110) of the macro pixel (100).

[15] The solid-state imaging device according to [14], wherein the active pixel circuits (180) of each macro pixel (100) include at least one red pixel circuit (180R) configured to detect red light, at least one green pixel circuit (180G) configured to detect green light, and at least one blue pixel circuit (180B) configured to detect blue light.

1. A solid-state imaging device, comprising:
a radiation sensitive circuit configured to continuously convert a first photocurrent generated by incident radiation into a pixel voltage signal and outputs a gain control signal based on a voltage level of the pixel voltage signal; and
an active pixel circuit configured to integrate a second photocurrent generated by incident radiation in an exposure period and convert a resulting electric charge into a pixel output voltage at a conversion gain controllable by the gain control signal.

2. The solid-state imaging device according to claim 1,
wherein the radiation sensitive circuit comprises a first photoelectric conversion element configured to generate the first photocurrent from radiation incident in a first detector region, and wherein the active pixel circuit comprises a second photoelectric conversion element configured to generate the second photocurrent from radiation incident in a second detector region neighboring the first detector region.

3. The solid-state imaging device according to claim 1,
wherein the radiation sensitive circuit comprises a first photoelectric conversion element configured to generate the first photocurrent and a photoreceptor circuit configured to convert the first photocurrent into the pixel voltage signal.

4. The solid-state imaging device according to claim 3,
wherein the photoreceptor circuit comprises a logarithmic amplifier circuit.

5. The solid-state imaging device according to claim 1,
wherein the radiation sensitive circuit comprises a light level judgement circuit configured to output an auxiliary signal, wherein the auxiliary signal has an active voltage level when a voltage level of the pixel voltage signal is higher than a gain threshold voltage.

6. The solid-state imaging device according to claim 5,
wherein the radiation sensitive circuit comprises a latch circuit configured to latch a result of a comparison between the pixel voltage signal and the gain threshold voltage to obtain the gain control signal.

7. The solid-state imaging device according to claim 1,
wherein the radiation sensitive circuit comprises a latch comparator circuit configured to obtain the gain control signal by comparing the pixel voltage signal with a gain threshold voltage and latching a result of the comparison in response to a latch control signal.

8. The solid-state imaging device according to claim 5, further comprising:
a threshold defining circuit configured to generate the gain threshold voltage as a function of a temperature and/or selected exposure data.

9. The solid-state imaging device according to claim 1, further comprising:
a flag signal output circuit configured to output a gain flag signal containing information about a voltage level of the gain control signal on a gain signal line.

10. The solid-state imaging device according to claim 9, further comprising:
a column processing circuit configured to receive the gain flag signal and to compile digital pixel data based on the gain flag signal and the pixel output voltage of the active pixel circuit.

11. The solid-state imaging device according to claim 1,
an event detection circuit configured to output an active event signal, when a change of the pixel voltage signal exceeds a predefined upper threshold voltage for event detection.

12. The solid-state imaging device according to claim 1,
wherein the active pixel circuit comprises a control element configured to change between a first state and a second state in response to the gain control signal, and wherein when the control element is in the first state a conversion gain of the active pixel circuit is higher than when the control element is in the second stage.

13. The solid-state imaging device according to claim 12,
wherein the active pixel circuit comprises a floating diffusion capacitor configured to store electric charge obtained by integrating the second photocurrent, and wherein the control element comprises a floating diffusion transistor configured to switch a supplementary capacitive structure in parallel with the floating diffusion capacitor in response to the gain control signal.

14. The solid-state imaging device according to claim 1,
wherein a macro pixel comprises one radiation sensitive circuit and a plurality of active pixel circuits, wherein the radiation sensitive circuit comprises a first photoelectric conversion element configured to generate the first photocurrent, and wherein each active pixel circuit comprises a second photoelectric conversion element configured to generate the second photocurrents, and wherein the active pixel circuits of the macro pixel receive the gain control signal output from the radiation sensitive circuit of the macro pixel.

15. The solid-state imaging device according to claim 14,
wherein the active pixel circuits of each macro pixel comprise at least one red pixel circuit configured to detect red light, at least one green pixel circuit configured to detect green light, and at least one blue pixel circuit configured to detect blue light.
